(19) United States
(12) Patent Application Publication
(10) Pub. No.: US 2024/0029529 A1
(43) Pub. Date: Jan. 25, 2024

(54) OUTDOOR SECURITY SYSTEMS AND METHODS

(71) Applicant: SkyBell Technologies IP, LLC, Irvine, CA (US)

(72) Inventor: Joseph Frank Scalisi, Yorba Linda, CA (US)

(21) Appl. No.: 18/375,605

(22) Filed: Oct. 2, 2023

Related U.S. Application Data
(63) Continuation of application No. 17/139,614, filed on Dec. 31, 2020, now Pat. No. 11,810,436.
Application No. 17/139,614 is a continuation of application No. 16/734,221, filed on Jan. 3, 2020, now Pat. No. 10,909,825.
Application No. 16/734,221 is a continuation-in-part of application No. 16/055,115, filed on Aug. 5, 2018, now abandoned.
(60) Provisional application No. 62/560,118, filed on Sep. 18, 2017.

(51) Int. Cl. G08B 13/196; G08B 5/38; H04R 1/02; H04R 1/08

(52) U.S. Cl. CPC G08B 13/19628; G08B 5/38; G08B 13/1966; G08B 13/19619; H04R 1/025; G08B 13/19684; G08B 13/19695; H04R 1/08; G08B 13/19663

(57) ABSTRACT

The disclosure includes a security system including an outdoor security device. In some embodiments, the outdoor security device comprises a housing, a light coupled to the housing and located within a hollow inner portion of the housing, and a camera and a lens coupled to the housing. In some embodiments, the security device comprises at least one directional microphone communicatively coupled to the camera and configured to determine a location of a detected sound whereby the camera performs a frame lock to capture an image associated with the detected sound.

### CROSS-REFERENCE TO RELATED APPLICATIONS

The entire contents of the following application are incorporated by reference herein: U.S. patent application Ser. No. 17/139,614, filed Dec. 31, 2020; entitled OUTDOOR SECURITY SYSTEMS AND METHODS.

The entire contents of the following application are incorporated by reference herein: U.S. patent application Ser. No. 16/734,221; filed Jan. 3, 2020; and entitled OUTDOOR SECURITY SYSTEMS AND METHODS.

The entire contents of the following application are incorporated by reference herein: U.S. patent application Ser. No. 16/055,115; filed Aug. 5, 2018; and entitled OUTDOOR SECURITY SYSTEMS AND METHODS.

The entire contents of the following application are incorporated by reference herein: U.S. Patent Application No. 62/560,118, filed Sep. 18, 2017; entitled OUTDOOR SECURITY SYSTEMS AND METHODS.

### BACKGROUND OF THE INVENTION

### Field

Various embodiments disclosed herein relate to security systems. Certain embodiments relate to outdoor security systems.

### Description of Related Art

Homes, offices, and other buildings sometimes include security systems to enable occupants of the buildings to remotely monitor their premises to deter and prevent unwanted visitors. One shortcoming of such security systems is that they are easily noticeable and therefore avoidable by perpetrators. Thus, there is a need for undiscernable security systems and methods to monitor premises.

### SUMMARY OF THE INVENTION

This disclosure includes a security system comprising an outdoor security device (e.g., a weatherproof security device) including a housing elongate along a first direction. The housing may comprise a top end, a bottom end located opposite the top end, and a hollow inner portion. The security device may include a light coupled to the housing and located within the hollow inner portion adjacent the bottom end. The light may face towards the top end. The security device may also include a camera coupled to the housing. The camera may face towards at least one of the top end and the bottom end. The security device may include a visual adjustment device coupled to the housing and aligned with an optical axis of the camera. The visual adjustment device may be arranged and configured to allow the camera to capture images along a radial direction around the security device. The radial direction may be perpendicular to the first direction.

In some embodiments, the visual adjustment device is located closer to the top end than the bottom end. In some embodiments, the visual adjustment device is coupled to the top end and the camera is located closer to the bottom end than the top end and the camera faces the top end. The camera may be located closer to the top end than the bottom end and the camera may face the bottom end.

The visual adjustment device may comprise at least one of a mirror and lens. In some embodiments, the visual adjustment device comprises a cone-shaped mirror that radially extends at least 90-degrees around a perimeter of the camera so that the camera captures images at least 90-degrees around a perimeter of the housing along a second direction that is perpendicular to the first direction. As well, in some embodiments, the visual adjustment device comprises a cone-shaped mirror that radially extends at least 180-degrees around a perimeter of the camera so that the camera captures images at least 180-degrees around a perimeter of the housing along a second direction that is perpendicular to the first direction. Even still, in some embodiments, the visual adjustment device comprises a cone-shaped mirror that radially extends 360-degrees around a perimeter of the camera so that the camera captures images 360-degrees around a perimeter of the housing along a second direction that is perpendicular to the first direction.

The security system may also include a remote computing device communicatively coupled to the camera and/or the security device. The weatherproof security device may be a first weatherproof security device and the system may further comprise a second weatherproof security device communicatively coupled to at least one of the first weatherproof security device and the remote computing device. The remote computing device may be a first remote computing device and the system may further include a second remote computing device communicatively coupled to at least one of the weatherproof security device and the first remote computing device. Even still, the weatherproof security device may be a first weatherproof security device and the system may further comprise a second weatherproof security device communicatively coupled to at least one of the first weatherproof security device, the first remote computing device, and the second remote computing device.

The weatherproof security device may further comprise a microphone coupled to the housing and a speaker coupled to the housing. The microphone and speaker may be arranged and configured to enable two-way communication between the weatherproof security device and the remote computing device. In some embodiments, the light is coupled to the housing via a low voltage electrical connection whereby the light receives electrical power from the low voltage electrical connection.

The camera may be coupled to the housing via a low voltage electrical connection wherein the camera receives electrical power from the low voltage electrical connection. The security system may further include a low voltage electrical cable and plug extending from the housing. At least one of the light and the camera may receive electrical power from the low voltage electrical cable and plug.

In some embodiments, the housing comprises a tube elongate along the first direction, and a base coupled to the elongate tube. The base may be rotatably coupled to the tube. In some embodiments, the base further comprises at least one aperture extending through the base such that moisture is able to escape the hollow inner portion of the housing. Even still, the system may further comprise a stake extending from the base along a third direction opposite the first direction.

Furthermore, in some embodiments, the visual adjustment device is rotatably coupled to the housing. As well, the camera and the light may be slideably coupled to the housing. The security system may further comprise a transparent material radially extending around the visual adjustment device. The transparent material may comprise at least one of glass, plastic, polycarbonate, and acrylic.

The security system may include a wireless communication module coupled to the housing. The wireless communication module may comprise at least one of a Wi-Fi extender, Wi-Fi booster, and Wi-Fi repeater. The wireless communication module may be coupled to the housing via a low voltage electrical connection. The wireless communication module may receive electrical power from the low voltage electrical connection.

In some embodiments, the system includes an antenna communicatively coupled to the wireless communication module. The antenna may be coupled to an outer surface of the housing. As well, the antenna may be located within the hollow inner portion.

The disclosure also includes a low voltage security device that includes a housing, a camera coupled to the housing, and a low voltage electrical connection coupled to the housing and electrically coupled to the camera. In some embodiments, the security device further includes a wireless communication module coupled to the housing and communicatively coupled to the camera. The wireless communication module may be arranged and configured to transmit images captured by the camera to a remote computing device.

The low voltage electrical connection may comprise a male connection configured to electrically couple to a low voltage female connection. Even still, the low voltage electrical connection may comprise a female connection configured to electrically couple to a low voltage male connection. The security device may include a light coupled to the housing, In this regard, the low voltage electrical connection may be electrically coupled to the light.

The disclosure also includes a wireless communication system comprising a weatherproof housing, a Wi-Fi extender coupled to the weatherproof housing, and a low voltage electrical connection coupled to the weatherproof housing and electrically coupled to the Wi-Fi extender. The system may further comprise an antenna communicatively coupled to the Wi-Fi extender. In some embodiments, the antenna is coupled to an outer surface of the weatherproof housing. Even still, in some embodiments, the antenna is located within an inner portion of the weatherproof housing.

Additionally, the disclosure includes a security system comprising an outdoor security device including a housing elongate along a first direction, the housing comprising a top end, a bottom end, and a hollow inner portion; a light coupled to the housing and located within the hollow inner portion; a camera and a lens coupled to the housing, the lens located between the camera and the top end such that the camera is configured to capture images around a perimeter of the outdoor security device; and at least one directional microphone communicatively coupled to the camera and configured to determine a location of a detected sound whereby the camera performs a frame lock to capture an image associated with the detected sound.

In some embodiments, the at least one directional microphone comprises a first port and a second port configured to determine the location of the detected sound whereby the camera performs the frame lock to capture the image associated with the detected sound.

In some embodiments, the at least one directional microphone comprises a first directional microphone and a second directional microphone each communicatively coupled to the camera, the first directional microphone and the second directional microphone located on opposite sides of the housing and configured to determine the location of the detected sound whereby the camera performs the frame lock to capture the image associated with the detected sound.

In some embodiments, the system includes a visual adjustment device coupled to the housing and located along the hollow inner portion of the housing adjacent the top end, wherein the visual adjustment device is aligned with the lens and the camera such that the visual adjustment device is configured to allow the camera to capture images around the perimeter of the outdoor security device. In some embodiments, the visual adjustment device comprises a cone-shaped mirror having a tip facing towards the camera and the lens. The lens may comprise a flat lens. In some embodiments, the lens comprises a convex lens configured to allow the camera to capture images around the perimeter of the outdoor security device.

In some embodiments, the camera is configured to capture images 360-degrees around the outdoor security device. In some embodiments, the camera is configured to capture images along a vertical field of view that is less than or equal to about 220-degrees.

In some embodiments, the system includes a substantially clear portion coupled to the housing and located adjacent the top end, wherein the camera is configured to capture images around the perimeter of the outdoor security device through the substantially clear portion.

In some embodiments, the system includes a power cord electrically coupled to at least one of the battery, the light, the camera, and the least one directional microphone, wherein the power cord is configured to receive power from an external power source.

In some embodiments, the system includes a battery electrically coupled to at least one of the power cord, the light, the camera, and the at least one directional microphone, wherein the battery is configured to be recharged via power received from the power cord, and the battery is configured to thereby provide power to at least one of the light, the camera, and the at least one directional microphone.

In some embodiments, the system includes a remote server communicatively coupled to at least one of the light, the camera, and the at least one directional microphone.

In some embodiments, the system includes a remote computing device communicatively coupled to least one of the light, the camera, the at least one directional microphone, and the remote server, wherein the remote computing device is configured to receive an alert in response to the at least one directional microphone receiving the detected sound.

In some embodiments, the light is configured to illuminate an area around the outdoor security device. As well, in some embodiments, the light is configured to illuminate and pulse in a strobing pattern. In some embodiments, the strobing pattern comprises a plurality of colors. Additionally, in some embodiments, the strobing pattern comprises a plurality of pulse rates.

In some embodiments, the system includes a speaker coupled to the housing and communicatively coupled to at least one of the light, the camera, and the at least one directional microphone.

In some embodiments, the system includes a wireless communication module coupled to the housing, wherein the wireless communication module comprises at least one of a Wi-Fi extender, Wi-Fi booster, and Wi-Fi repeater; and an antenna coupled to the housing and communicatively coupled to the wireless communication module.

The disclosure also includes methods of using a security system that includes an outdoor security device comprising the steps of providing the outdoor security device comprising a housing, a light located within a hollow inner portion of the housing, a camera and a lens coupled to the housing whereby the lens is located between the camera and a top end of the housing, and at least one directional microphone communicatively coupled to the camera and configured to determine a location of a detected sound. Methods may also include detecting a sound via the at least one directional microphone; and in response to the detecting, capturing, via the camera, an image associated with the sound.

In some embodiments, the capturing comprises the camera performing a frame lock of the image associated with the detected sound. In some embodiments, the detecting comprises detecting the sound along a radial field of view that is 360-degrees around the outdoor security device and a vertical field of view up to 220-degrees from the outdoor security device.

In some embodiments, the method includes comprising providing power to at least one of the battery, the light, the camera, and the at least one directional microphone via a power cord electrically coupled to an external power source.

In some embodiments, the method includes providing power to at least one of the light, the camera, and the at least one directional microphone via a battery electrically coupled to the housing.

In some embodiments, the method includes providing power to at least one of the battery, the light, the camera, and the at least one directional microphone via the power cord during a first time interval; and providing power to at least one of the light, the camera, and the at least one directional microphone via the battery during a second time interval.

In some embodiments, the method includes recharging the battery via the power cord and the external power source during at least one of the first time interval and the second time interval.

In some embodiments, the method includes, in response to the detecting, receiving, via a remote computing device, an alert. In some embodiments, the method includes, in response to the detecting, illuminating the light and pulsing the light in a strobing pattern. In some embodiments, the method includes, in response to the detecting, emitting a sound from a speaker coupled to the housing and communicatively coupled to at least one of the light, the camera, and the at least one directional microphone.

The embodiments described above include many optional features and aspects. Features and aspects of the embodiments can be combined.

### BRIEF DESCRIPTION OF DRAWINGS

These and other features, aspects, and advantages are described below with reference to the drawings, which are intended to illustrate, but not to limit, the invention. In the drawings, like characters denote corresponding features consistently throughout similar embodiments.

FIG. 1 illustrates a security device in an environment of use, according to some embodiments.

FIG. 2 illustrates a front view of a security device, according to some embodiments.

FIGS. 3 and 4 illustrate front views of security devices having a camera and an optical axis, according to some embodiments.

FIGS. 5a, 5b, and 5c illustrate top views of visual adjustment devices, according to some embodiments.

FIG. 6 illustrates a security device and a remote computing device, according to some embodiments.

FIG. 7 illustrates first and second security devices and first and second remote computing devices, according to some embodiments.

FIG. 8 illustrates an exploded view of a security device, according to some embodiments.

FIG. 9 illustrates a base of a security device, according to some embodiments.

FIGS. 10a and 10b illustrate housings of various security devices, according to some embodiments.

FIGS. 11, 12, 13, and 14 illustrate various communication configurations, according to some embodiments.

FIGS. 15, 16, 17, and 18a illustrate partial views of various security devices, according to some embodiments.

FIG. 18b illustrates a security device and one or more remote sensors in an environment of use, according to some embodiments.

FIG. 19 illustrates a security device and a close-up view of a camera and lens, according to some embodiments.

FIG. 20 illustrates another security device and a close-up view of a camera and lens, according to some embodiments.

FIG. 21 illustrates a partial view of a security device illustrating a directional microphone having ports, according to some embodiments.

FIGS. 22a, 22b, 22c, and 22d illustrate a field of view of a security device, according to some embodiments.

FIG. 23 illustrates an exploded view of a security device having a battery and a power cord electrically coupled to an external power source, according to some embodiments.

FIG. 24 illustrates a security device being illuminated, according to some embodiments.

FIGS. 25, 26, 27, 28, and 29 illustrate methods of using various security devices, according to some embodiments.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Communication systems can provide a secure and convenient way for a remotely located individual to communicate with a person who is approaching a sensor, such as a proximity sensor or motion sensor, or with a person who rings a doorbell, which can be located in a doorway, near an entrance, or within 15 feet of a door. Some communication systems allow an individual to hear, see, and talk with visitors who approach at least a portion of the communication system and/or press a button, such as a doorbell's button. For example, communication systems can use a computing device to enable a remotely located person to see, hear, and/or talk with visitors. Computing devices can include computers, laptops, tablets, mobile devices, smartphones, cellular phones, and wireless devices (e.g., cars with wireless communication). Example computing devices include the iPhone, iPad, iMac, MacBook Air, and MacBook Pro made by Apple Inc. Communication between a remotely located person and a visitor can occur via the Internet, cellular networks, telecommunication networks, and wireless networks.

### COMPONENT INDEX

1—security system
10—security device
12—housing
14—top end
16—bottom end
17—inner portion
20—light
22—camera
23—lens
24—visual adjustment device
26—optical axis
28—motion detector
30—remote computing device
32—remote server
34—the cloud
40—low voltage connection
41—power cord
43—battery
44—tube
45—external power
46—base
48—aperture
50—stake
52—transparent material
54—microphone
55—at least one directional microphone
55a—first directional microphone
55b—second directional microphone
56—speaker
58a—first port
58b—second port
60—wireless communication module
62—antenna
64—field of view
66—radial field of view
67—vertical field of view
68—wireless communication
70—image frame lock
72—remote sensor

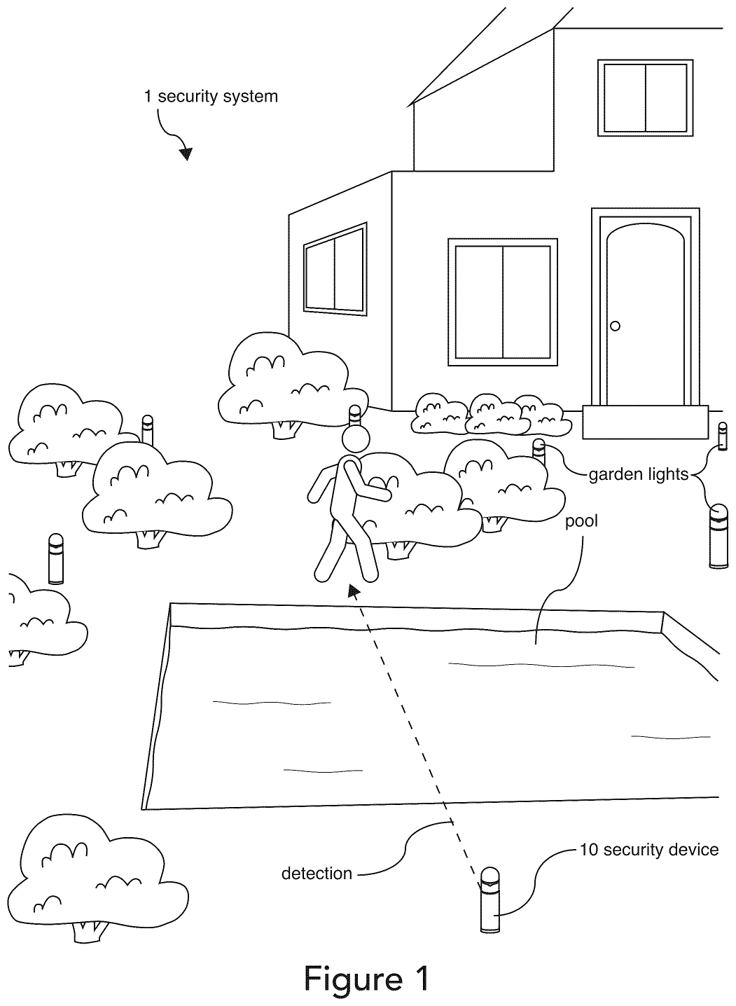

FIG. 1 illustrates a security device 10 located in an environment of use, such as a residential backyard. While in use, the security device 10 may visually and audibly detect motion and sounds in the backyard environment and then send a notification to a remote computing device to alert the resident, or other person, of the detected motion and/or sound. The security device 10 may have a substantially similar aesthetic appearance to a standard garden light, as shown in FIG. 1. In this regard, the security device 10 may blend in with its surroundings whereby unsuspecting trespassers are unable to distinguish between the security device 10 and the standard garden light. For the purposes of this disclosure, the terms weatherproof and outdoor may be used interchangeably. In some embodiments, a security system 1 comprises a plurality of security devices working as a security network. For example the system 1 may include a first outdoor security device 10a, a second outdoor security device 10b, a third outdoor security device 10c, and so on. The network may comprise similar or different security devices 10 utilizing some or all of the functionality and components described throughout this disclosure.

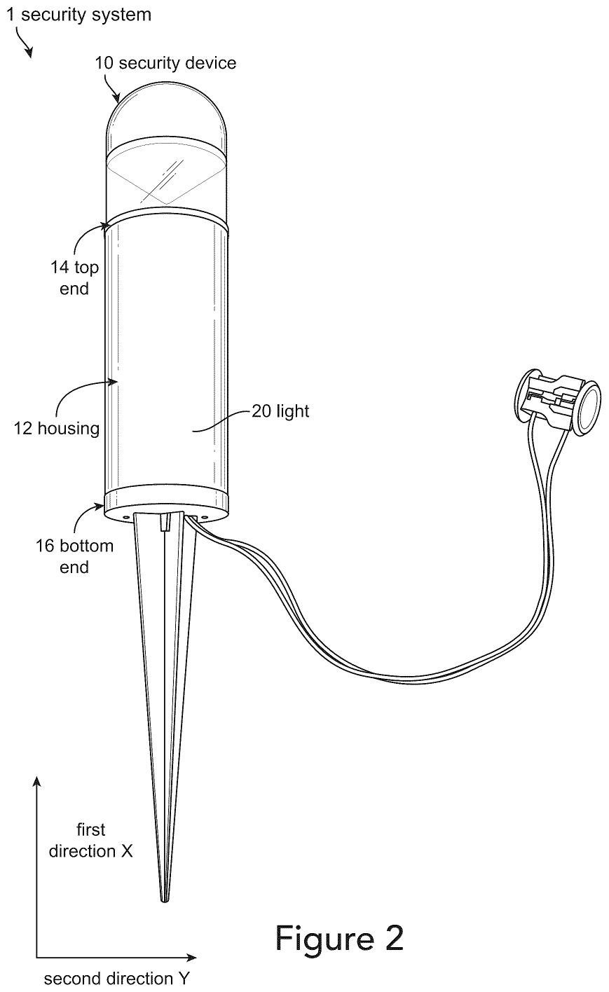

FIG. 2 illustrates a front view of a security system 1 comprising a weatherproof security device 10 that includes a housing 12 elongate along a first direction X. The housing 12 may comprise a top end 14, a bottom end 16 located opposite the top end 14, and a hollow inner portion. The security device 10 may also include a light 20 coupled to the housing 12 and located within the hollow inner portion 17 adjacent the bottom end 16. In some embodiments, the light 20 faces towards the top end 14.

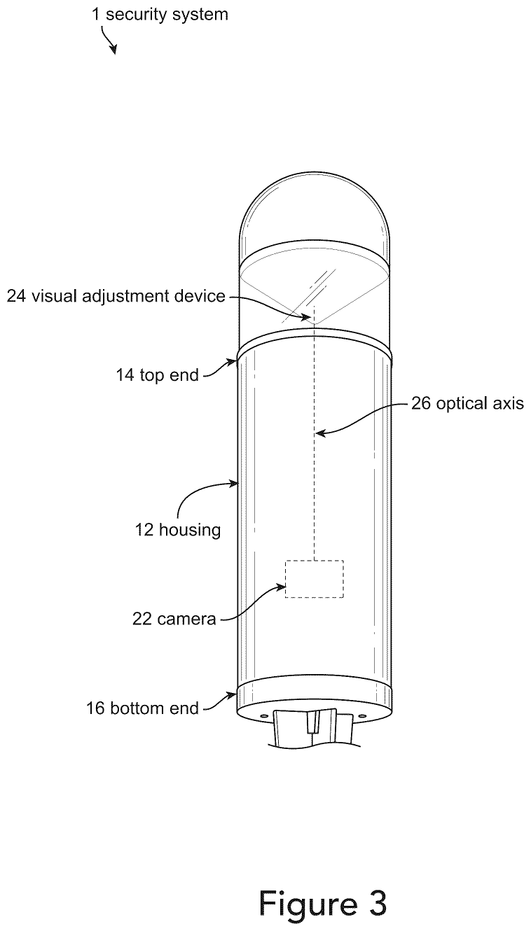

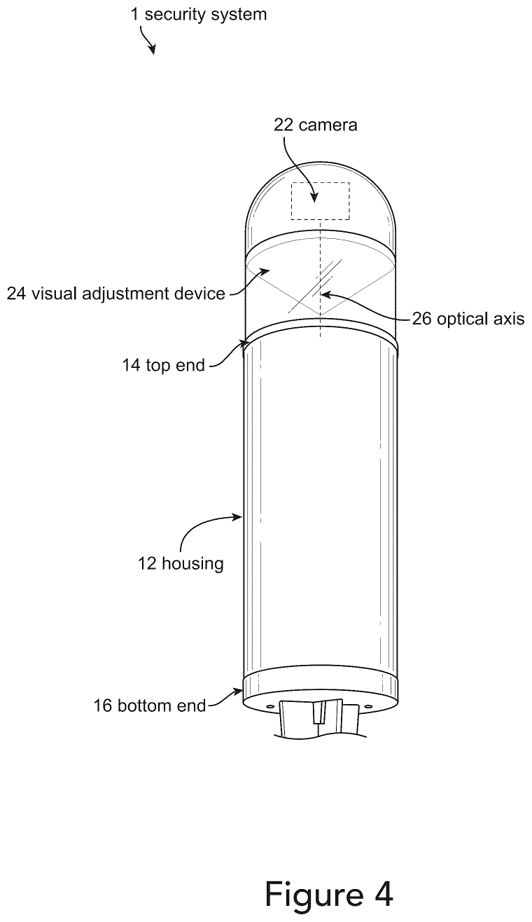

According to FIGS. 3 and 4, the security device 10 may also include a camera 22 coupled to the housing 12, and a visual adjustment device 24 coupled to the housing 12 and aligned with an optical axis 26 of the camera 22. The visual adjustment device 24 may be arranged and configured to allow the camera 22 to capture images along a radial direction (or second direction Y) around the security device 1. The visual adjustment device 24 may comprise a mirror and/or a lens, whereby either is arranged and configured to enhance the focus and/or capture images radially located around the security device. According to FIG. 2, the radial direction is perpendicular to the first direction X.

As shown in FIGS. 3 and 4, the visual adjustment device 24 may be located closer to the top end 14 than the bottom end 16. In some embodiments, the visual adjustment device 24 is directly or indirectly coupled to the top end 14. As shown in FIG. 3, the camera 22 may be located closer to the bottom end 16 than the top end 14. In this regard the camera 22 may face the top end 14 and/or the visual adjustment device 24. Alternatively, as shown in FIG. 4, the camera 22 may be located closer to the top end 14 than the bottom end 16. Accordingly, the camera 22 may face the bottom end 16 and/or the visual adjustment device 24. In many embodiments, the camera 22 faces the visual adjustment device 24 so that the camera 22 can capture images radially located around the security device 10.

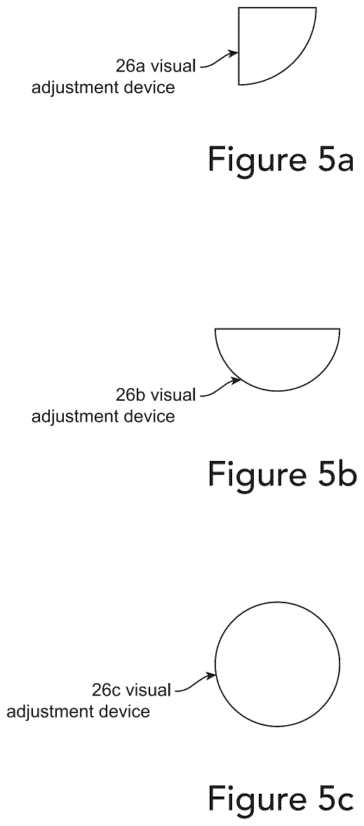

As shown in FIGS. 2-4, the visual adjustment device may define a cone-shape. As illustrated in the top-down view in FIG. 5a, the cone-shape may radially extend at least 90-degrees around a perimeter of the camera 22 so that the camera 22 captures images at least 90-degrees around a perimeter of the housing 12 along a second direction Y that is perpendicular to the first direction X. As shown in FIG. 5b, the cone-shape may radially extend at least 180-degrees around a perimeter of the camera 22 so that the camera 22 captures images at least 180-degrees around a perimeter of the housing 12 along the second direction Y. Even still, as illustrated in FIG. 5c, the cone-shape may radially extend 360-degrees around a perimeter of the camera 22 so that the camera 22 captures images 360-degrees around a perimeter of the housing 12 along the second direction Y.

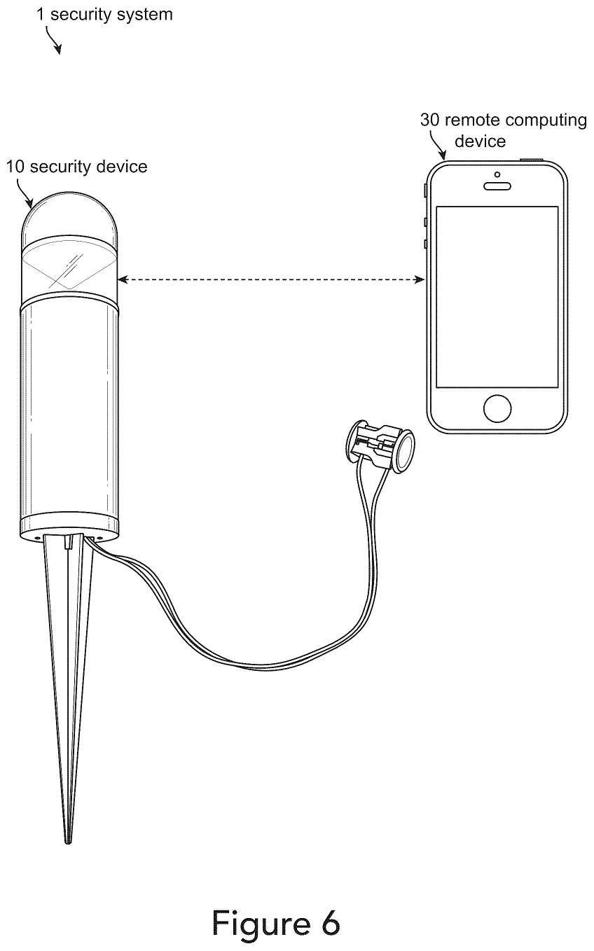

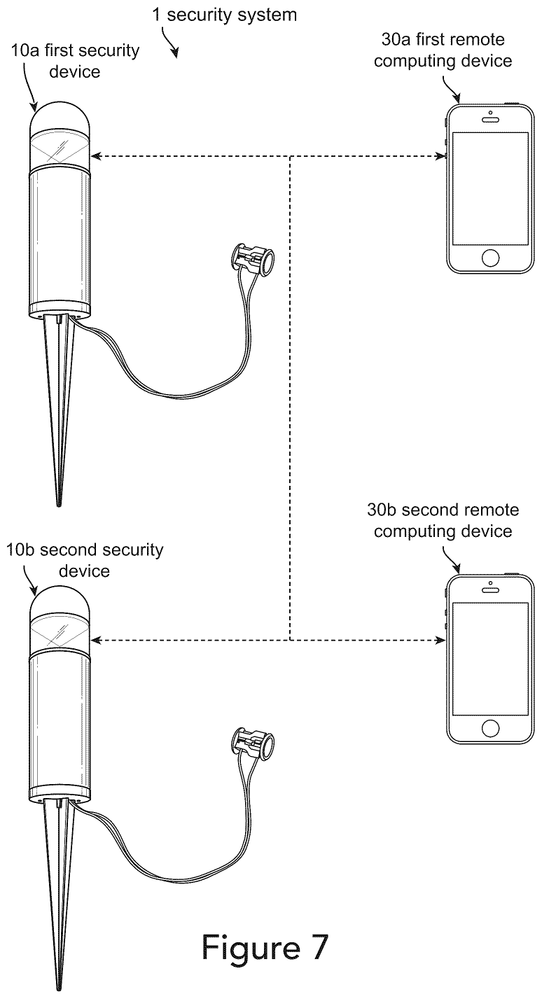

Now with reference to FIG. 6, the security system 1, may further include a remote computing device 30 communicatively coupled to the security device 10 and/or the camera 22. As shown in FIG. 7, in some embodiments, the system 1 may include first and second weatherproof security devices 10a, 10b communicatively coupled to first and second weatherproof security device 10a, 10b. It should be appreciated that any combination of first and second security devices 10a, 10b may be communicatively coupled to any combination of first and second remote computing devices 30a, 30b.

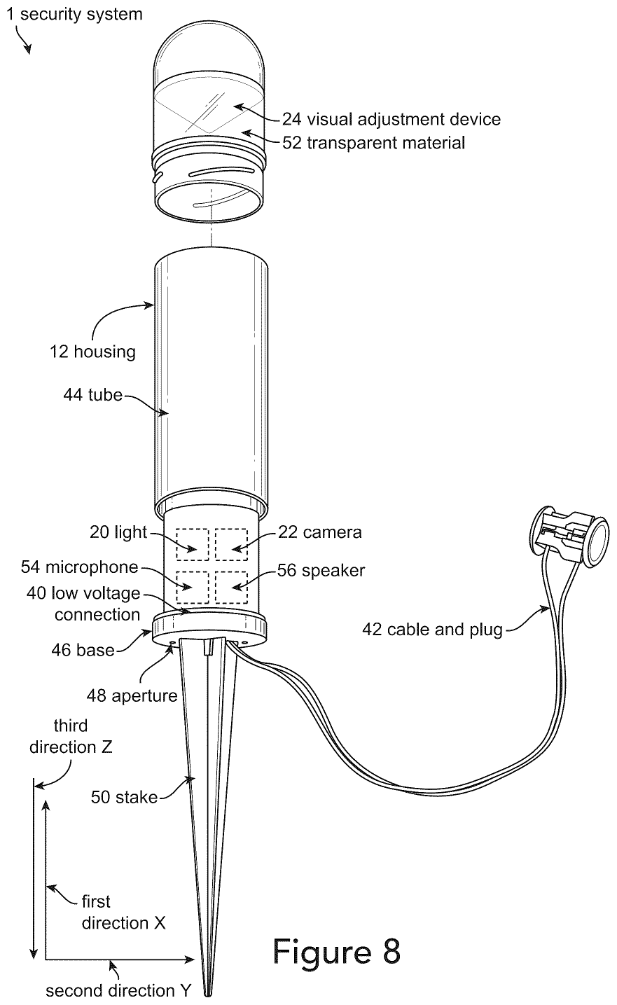

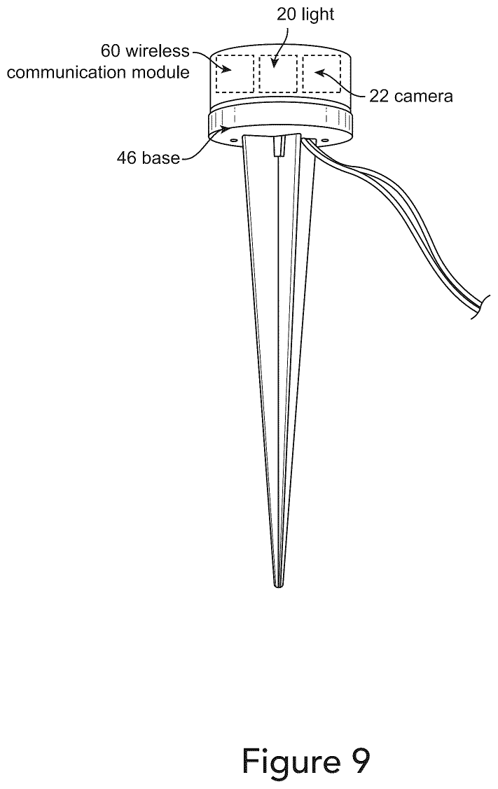

As shown in FIGS. 8, 9, 10a, and 10b, the security device 10 may include a microphone 54 coupled to the housing 12 and a speaker 56 coupled to the housing 12. The microphone 54 and speaker 56 may be arranged and configured to enable two-way communication between the security device 10 and the remote computing device 30.

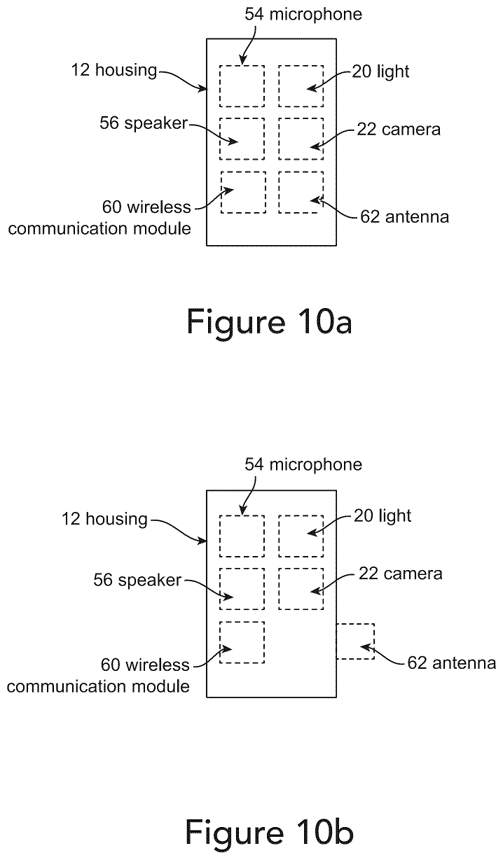

To enable communication between the security device 10 and other devices, such as remote computing devices 30, the security device 10 may comprise a wireless communication module 60 coupled to the housing 12. In some embodiments, the wireless communication module 60 comprises at least one of a Wi-Fi extender, Wi-Fi booster, and Wi-Fi repeater. The security device 10 may also include an antenna 62 communicatively coupled to the wireless communication module 60. As illustrated in FIG. 10a, the antenna 62 may be located within the hollow inner portion 17 of the housing 12. Even still, as shown in FIG. 10b, the antenna 62 may be coupled to an outer surface of the housing 12.

The security device 10 may be powered by a low voltage power supply transmitted through a low voltage electrical cable and plug 41 extending from the housing 12. Accordingly, any of the components, such as the light 20 and/or camera 22 may be coupled to the housing 12 via a low voltage electrical connection 40, whereby the light 20 and/or camera 22 may receive electrical power from the low voltage electrical connection 40.

As illustrated in FIG. 8, the housing 12 may include a tube 44 elongate along the first direction X and a base 46 coupled to the elongate tube 44. In some embodiments, the base 46 is rotatably coupled to the tube 44. Even still, in some embodiments, the base 46 further comprises at least one aperture 48 extending through the base 46 such that moisture is able to escape the hollow inner portion 17 of the housing 12. As well, the security device 10 may include a stake 50 extending from the base along a third direction Z opposite the first direction X.

The various components of the security device 10 may be coupled together via a variety of coupling mechanisms. For example, the visual adjustment device 24 may be rotatably coupled to the housing 12. As well, the camera 22 and light 20 may be slideably coupled to the housing 12, such as via a low voltage electrical connection (e.g. two electrical prongs).

With continued reference to FIG. 8, the security device 10 may further include a transparent material 52 (e.g., substantially clear portion) that radially extends around the visual adjustment device 24. In some embodiments, the transparent material 52 is glass, plastic, polycarbonate, and/or acrylic.

It should be appreciated that the security device 10 may be implemented with any combination of components. In some embodiments, the security device 10 comprises a housing 12, a camera 22 coupled to the housing 12, and a low voltage electrical connection 40 coupled to the housing 12 and electrically coupled to the camera 22. Some embodiments may also include the wireless communication module 60 coupled to the housing 12 and communicatively coupled to the camera 22. In this regard, the wireless communication module 60 is arranged and configured to transmit images captured by the camera 22 to the remote computing device 30.

In some embodiments, the security device 10 is referred to as a wireless communication system that includes a weatherproof housing 12, a Wi-Fi extender 60 coupled to the weatherproof housing 12, and a low voltage electrical connection 40 coupled to the weatherproof housing 12 and electrically coupled to the Wi-Fi extender 60. In such embodiments, the wireless communication system may further include an antenna 62 communicatively coupled to the Wi-Fi extender 60.

The security device 10 may also include different types of low voltage electrical connections. In some embodiments, the low voltage electrical connection 40 comprises a male connection configured to electrically couple to a low voltage female connection. Alternatively, the low voltage electrical connection 40 comprises a female connection configured to electrically couple to a low voltage male connection. Accordingly, the components (e.g. light 20, camera 22, etc.) may be electrically coupled to the security device 10 via the opposite connection type. For example, if the security device 10 includes a female connection, then the light 20 may include a male connection.

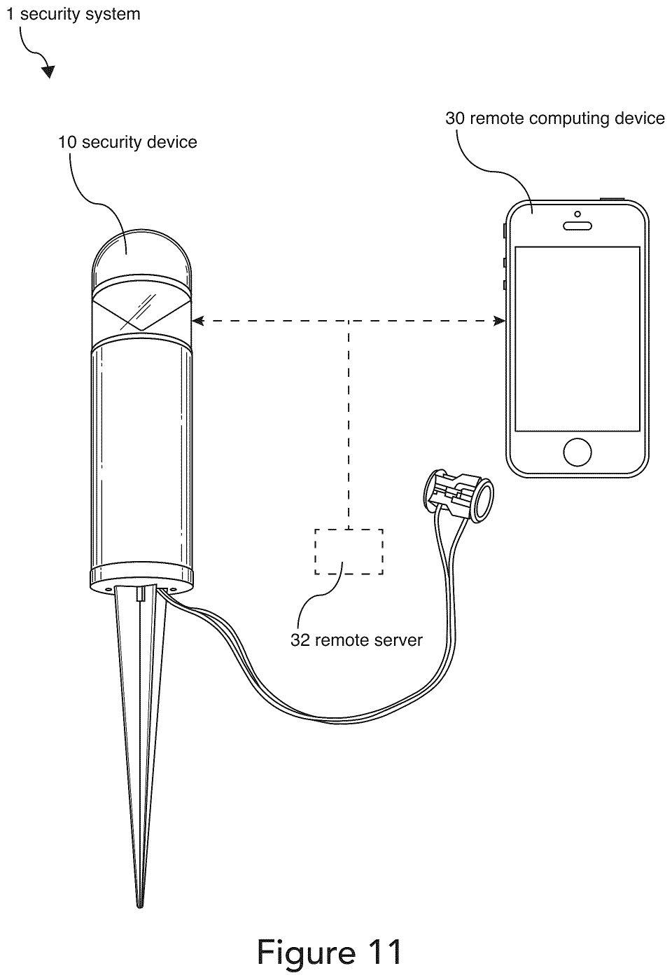

As shown in FIGS. 11-14, the security system 1 may be configured in a variety of scenarios to ultimately communicatively couple the security device 10 to the remote computing device 30. With reference to FIG. 11, the system 1 may be configured such that the security device 10 is communicatively coupled to a remote server 32 (or a plurality of remote servers 32), which is thereby communicatively coupled to the remote computing device 30. In this regard, the security device 10 is indirectly communicatively coupled to the remote computing device 30, via the remote server 32.

Accordingly, the system 1 may also include the remote computing device 30 communicatively coupled to least one of the light 20, the camera 22, the at least one directional microphone 55, and the remote server 32. The remote computing device 30 may be configured to receive an alert in response to the security system 1 detecting the presence of the person. More specifically, the remote computing device 30 may be configured to receive an alert in response to the at least one directional microphone 55 receiving the detected sound and/or the motion detector 28 detecting a motion. The alert may comprise an image captured by the camera 22.

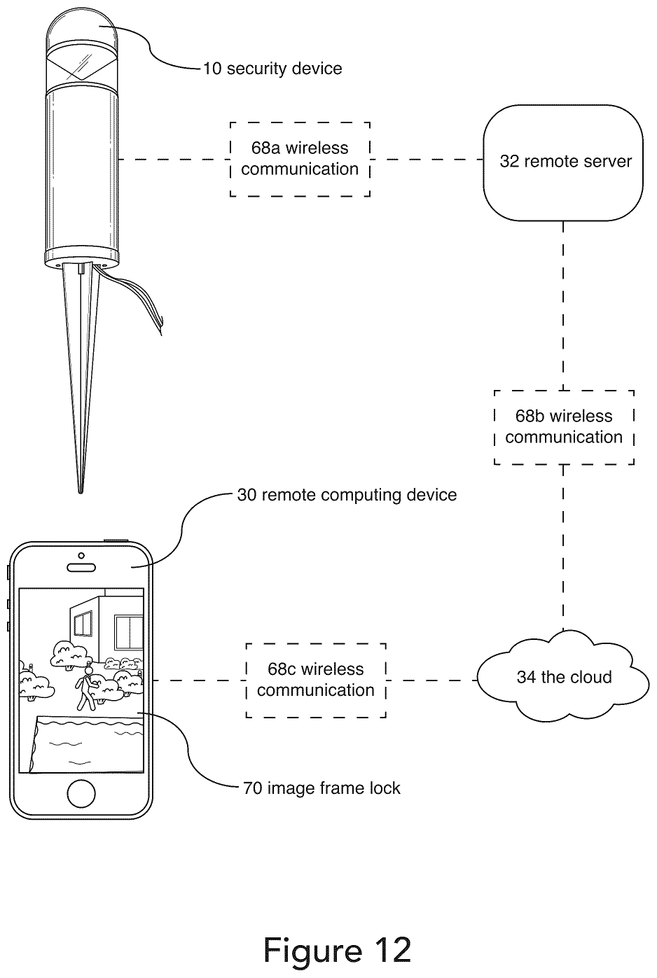

FIG. 12 illustrates a communication configuration whereby the security device 10 is communicatively coupled to the remote computing device 30, via the remote server 32 and the cloud 34. In this regard, the security device 10 is communicatively coupled to the remote server 32, which is communicatively coupled to the cloud 34, which is ultimately communicatively coupled to the remote computing device 30. Stated differently, the security device 10 is indirectly communicatively coupled to the remote computing device 30, via the remote server 32 and the cloud 34. As shown in FIG. 12, various wireless communications 68a, 68b, 68c may be transferred between the various communication components, such as the security device 10, remote server 32, cloud 34, and the remote computing device 30. It should be appreciated that the wireless communications 68 may be sent from or to the security device 10. In this regard, if the security device 10 detects a motion or sound, the security device 10 may send wireless communication 68 to the remote computing device 30, via none or at least one of the remote server 32 and the cloud 34. Additionally, the system 1 is designed to enable two-way communication. In this regard, the remote computing device 30 may be able to send a wireless communication 68 to the security device 10, via none or at least one of the remote server 32 and the cloud 34.

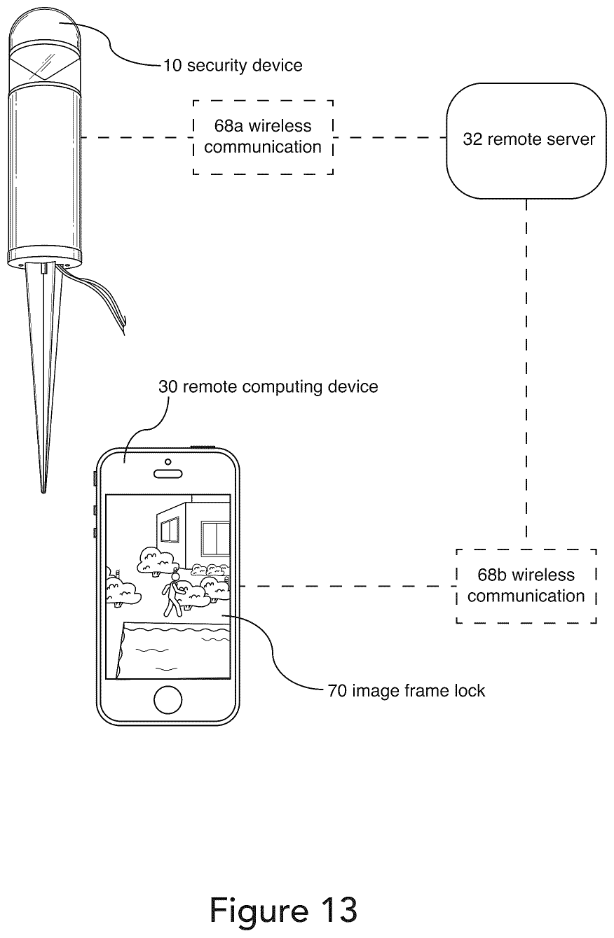

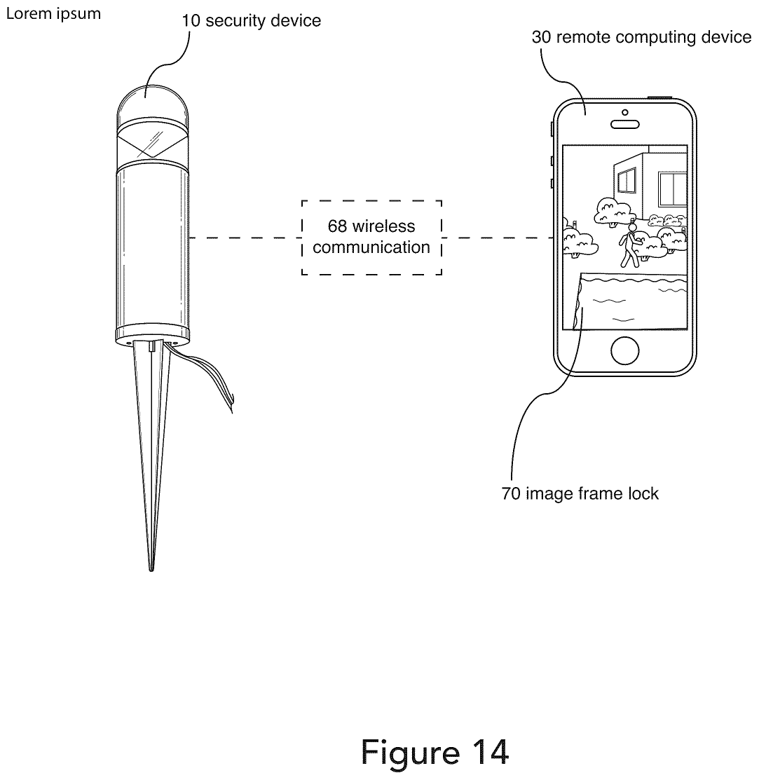

FIG. 13 illustrates an additional communication configuration similar to that of FIG. 11. FIG. 13 shows that wireless communications 68 may be sent from and to the security device 10. As shown in FIG. 14, system 1 may be configured to enable peer-to-peer communications whereby the security device 10 is communicatively coupled directly to the remote computing device 30.

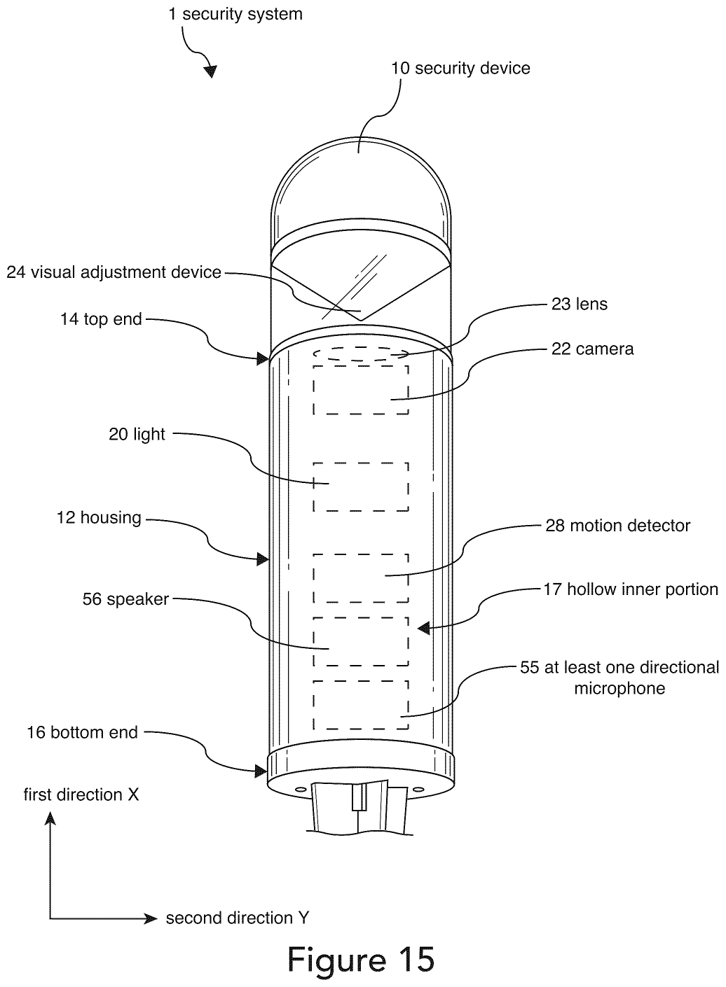

As shown in FIG. 15, the security system 1 includes an outdoor security device 10 comprising a housing 12 elongate along a first direction X. The housing 12 comprises a top end 14, a bottom end 16 located opposite the top end 14, and a hollow inner portion 17. The security device 10 may include a light 20 coupled to the housing 12 and located within the hollow inner portion 17. The security device 10 may also include a camera 22 and a lens 23 coupled to the housing 12. In some embodiments, the lens 23 is located between the camera 22 and the top end 14 such that the camera 22 is configured to capture images around a perimeter of the outdoor security device 10. In some embodiments, the security device 10 includes at least one directional microphone 55 communicatively coupled to the camera 22 and configured to determine a location of a detected sound whereby the camera 22 performs a frame lock 70 to capture an image associated with the detected sound. The system 1 may also include additional components, such as a visual adjustment device 24, a light 20, a motion detector 28, and a speaker 56, which will be discussed in more detail later.

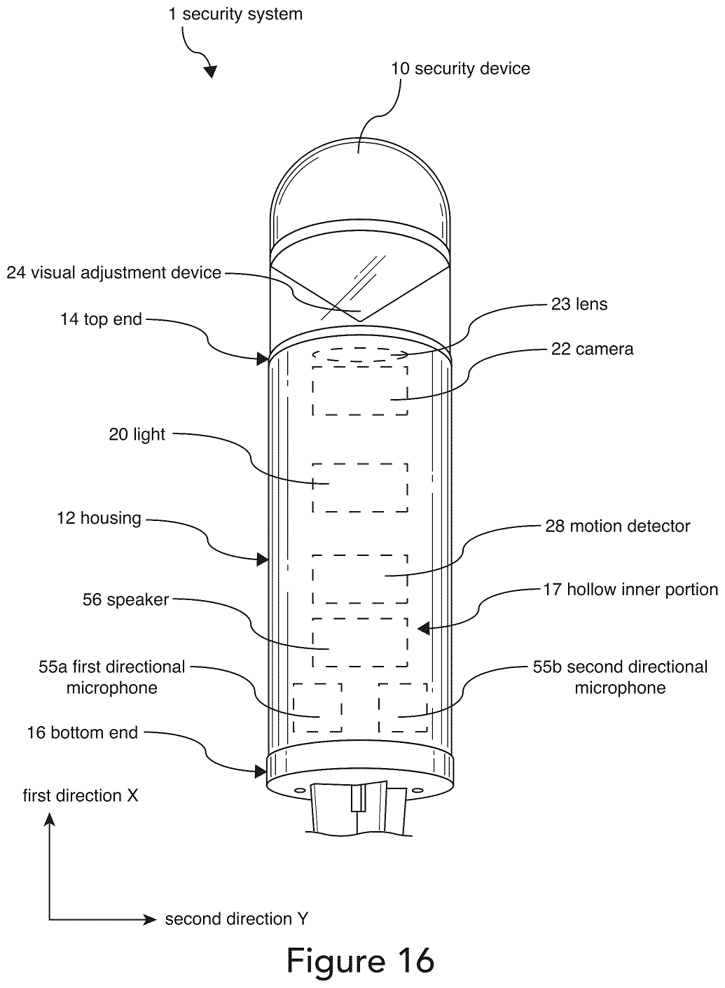

As illustrated in FIGS. 15, 16, and 17, the system 1 may be implemented with one directional microphone or a plurality of directional microphones. Additionally, the at least one directional microphone 55, 55a, 55b may be positioned in any location on or inside the security device 10, such as inside the top end 14, inside the bottom end 16, any location within the hollow inner portion 17b, embedded within the housing 12, or any place along an outer surface of the security device 10 or housing 12. Furthermore, for multiple directional microphone embodiments, the microphones 55a and 55b may be arranged with respect to each other. As shown in FIG. 16, the first directional microphone 55a and the second directional microphone 55b may be located on opposite sides of the housing 12. In some embodiments, the first directional microphone 55a and the second directional microphone 55b are coupled at about the same vertical location on the housing 12.

FIG. 16 shows that the security device 10 may also include a speaker 56 coupled to the housing and communicatively coupled to at least one of the light 20, the camera 22, and the at least one directional microphone 55. The speaker 56 may be configured to enable two-way communication between the security device 10 and the remote computing device 30. Moreover, the speaker can be configured to emit various sounds in response to the system 1 detecting the presence of an intruder. For example, if an intruder enters a swimming pool located within the field of view 64 of the security device 10, the speaker 56 may emit a warning message, such as “Please exit the pool immediately. The homeowner and the authorities have been notified!”

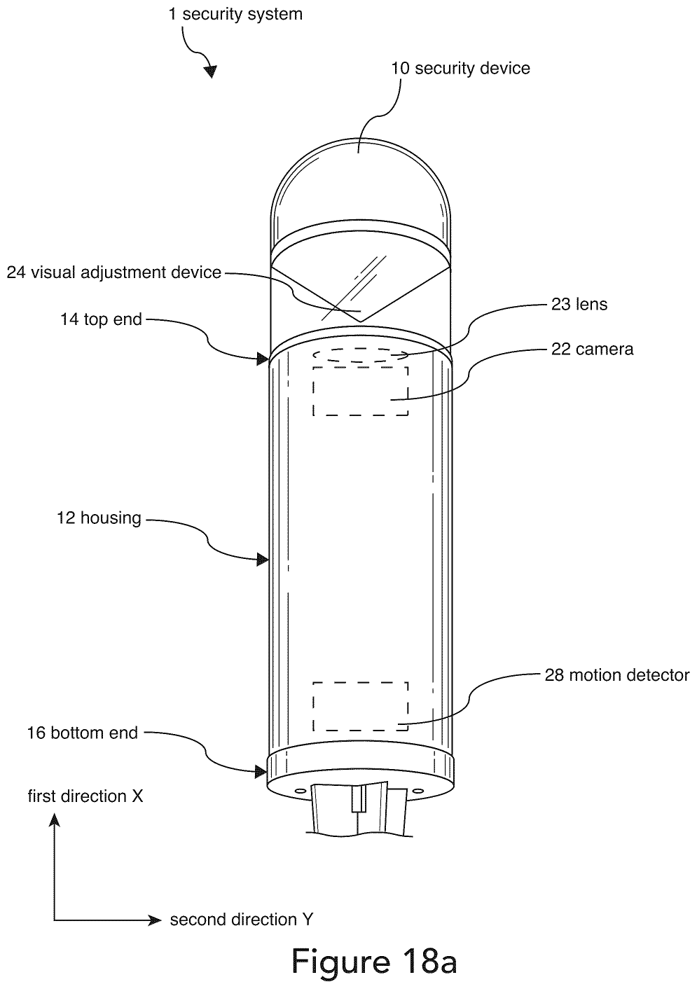

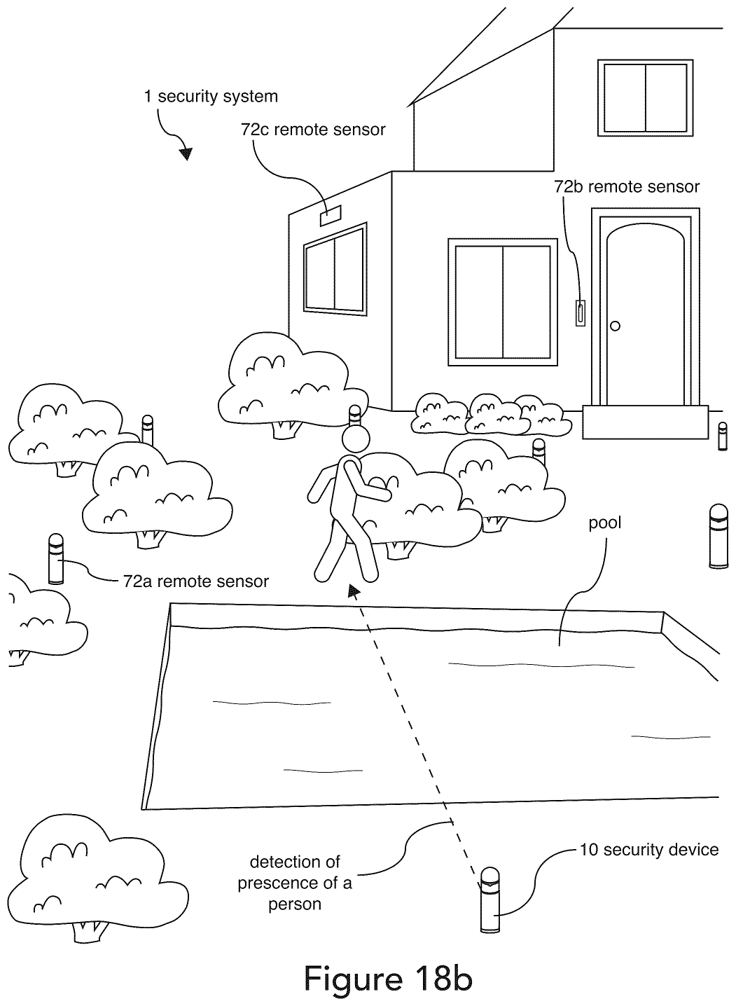

As shown in FIG. 18a, the system 1 may also include a motion detector 28 communicatively coupled to the camera 22. The motion detector 28 may thereby be configured to determine the location of a motion whereby the camera 22 performs a frame lock 70 on a location of the motion to capture an image associated with the motion. The motion detector 28 may comprise a passive infrared sensor (PIR), ultrasonic sensor, microwave sensor, tomographic sensor and any combination of sensor types. Additionally, the system 1 may be implemented with at least one directional microphone 55, or a motion detector 28, or both.

Any of the components described throughout this disclosure, such as the at least one directional microphone 55 and/or the motion detector 28, may be implemented as one or more remote sensors. In this regard, the at least one directional microphone 55 may be one or more directional microphones located remotely with respect to the security device 10. Additionally, the motion detector 28 may be located remotely with respect to the security device 10. Accordingly, any of the remote sensors may be communicatively coupled to the security device via a wireless or wired connection. The remote sensors may receive power from a power source that is separate from the security device 10 or receive power directly from the security device 10.

Now with reference to FIG. 18b, the security device 10 may be communicatively coupled to any variety of remote sensors that detect activity around the security device 10. In response to the remote sensor(s) 72 detecting the activity, the security device 10 may perform any of the features described throughout this disclosure, including performing the frame lock and sending and/or receiving a wireless communication (e.g., an alert) to/from the remote computing device 30. In some embodiments, the system 1 includes a first remote sensor 72a (e.g., a connected yard light, including another security device 10), a second remote sensor 72b (e.g., an electronic doorbell, including a smart doorbell), and a third remote sensor 72c (e.g., a connected house light, including a motion detecting light source).

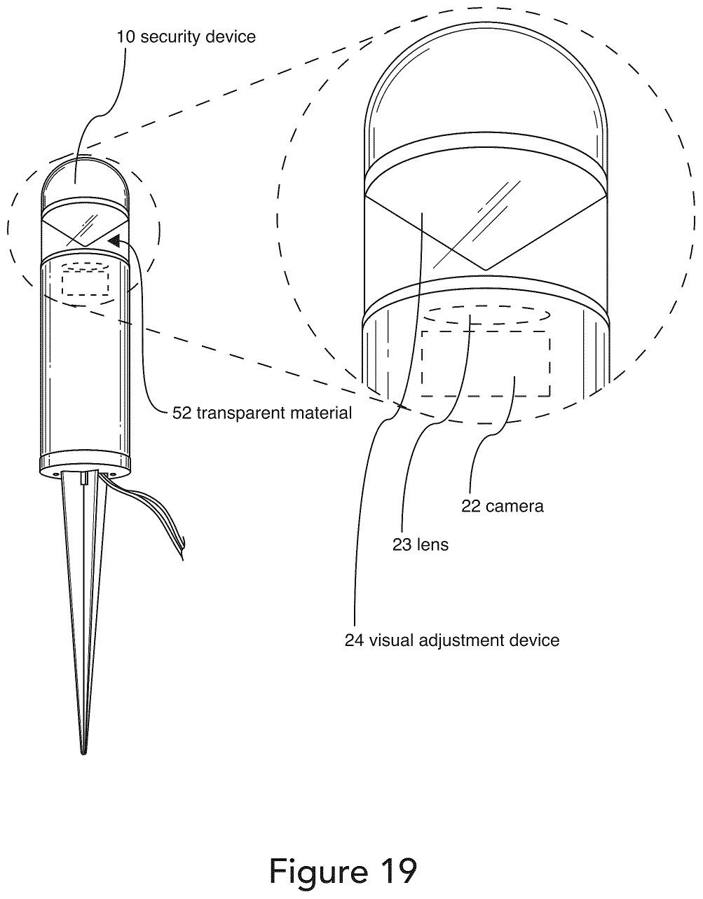

FIG. 19 illustrates embodiments whereby the system 1 includes a visual adjustment device 24 configured to allow the camera 22 to see the periphery of the security device 10. In such embodiments, the system 1 may include the camera and a lens 23, such as a flat lens, aimed at the visual adjustment device 24 and configured to enable the camera 22 to visually and clearly detect images reflected by the visual adjustment device 24. Stated differently, the visual adjustment device 24 may thereby be aligned with the lens 23 and the camera 22 such that the visual adjustment device is configured to allow the camera to capture images around the perimeter of the outdoor security device 10. As shown, the visual adjustment device 24 may be coupled to the housing 12 and located along the hollow inner portion 17 of the housing 12 adjacent the top end 14. The visual adjustment device 24 may comprise a cone-shaped mirror having a tip facing towards the camera 22 and the lens 23.

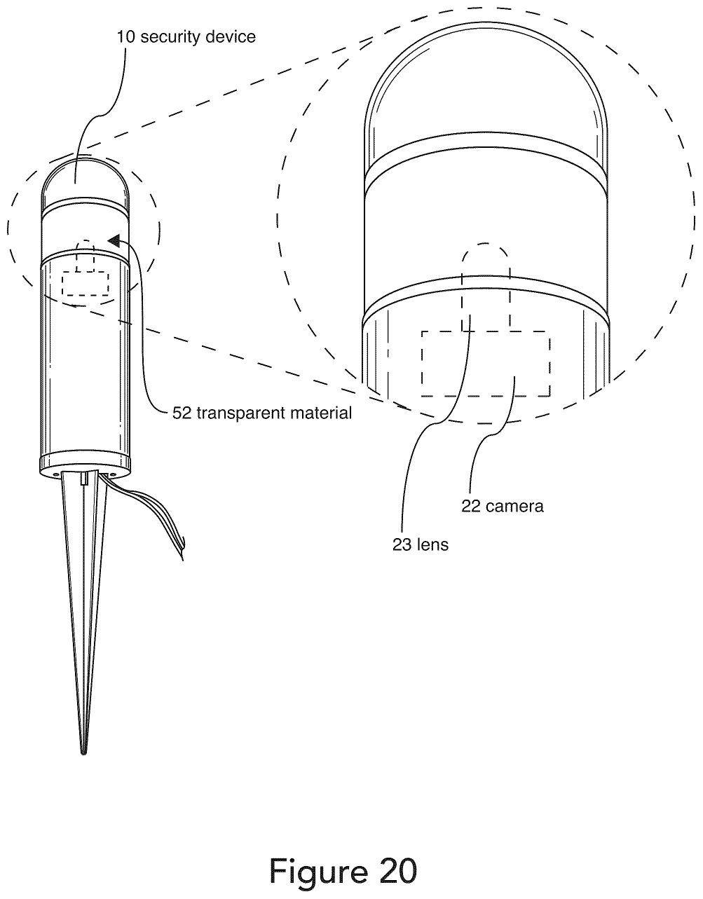

The security device 10 may also include a transparent material 52 coupled to the housing and located adjacent the top end. As shown in FIGS. 19 and 20, the transparent material 52 is configured to allow the camera 22 to capture images around the perimeter of the outdoor security device 10. The transparent material 52 may comprise a substantially clear portion that is configured to protect the camera 22 and other components from moisture and other outdoor elements that may adversely affect the device 10.

As shown in FIG. 20, the system 1 may also be configured whereby the security device 10 comprises a convex lens 23 configured to allow the camera 22 to capture images around the perimeter of the outdoor security device 10. In some embodiments, the security device 10 may comprise a visual adjustment device 24. However, in some embodiments, the security device 10 may not comprise the visual adjustment device 24, as shown in FIG. 20. As illustrated in FIG. 20, the convex lens may be positioned such that the convex lens has a line of sight through the transparent material 52.

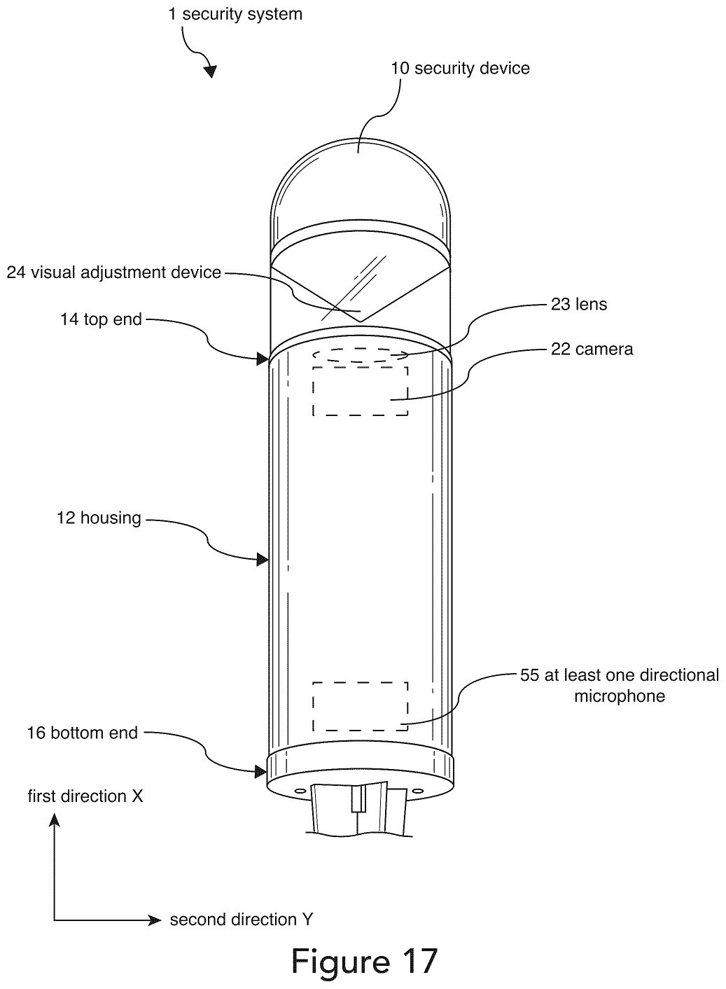

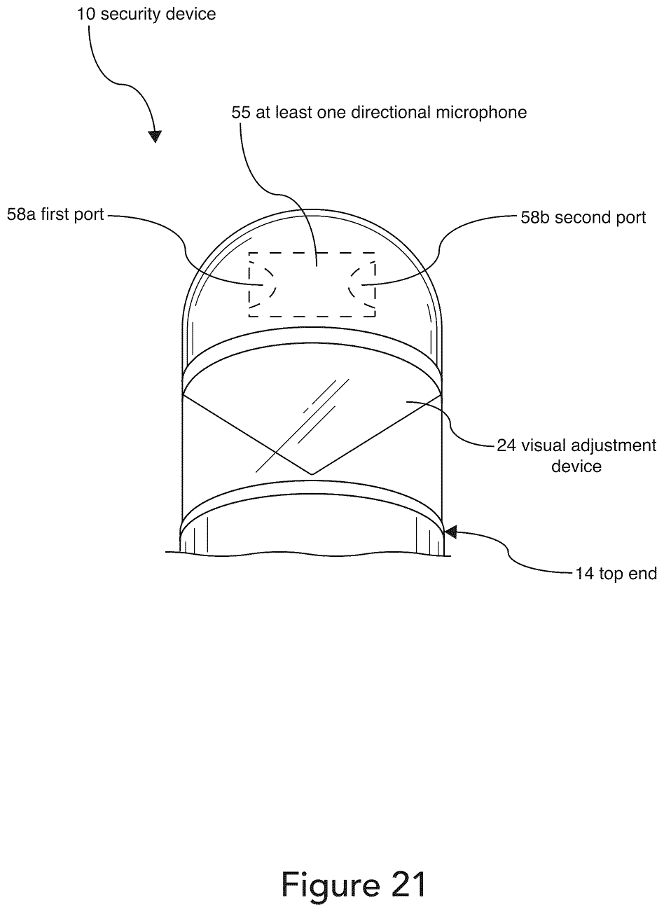

With reference to FIG. 21, the at least one directional microphone 55 may comprise a first port 58a and a second port 58b. In some embodiments, the at least one directional microphone 55 includes one port, while in other embodiments, the at least one directional microphone 55 includes more than two ports. With respect to FIG. 17, together the first and second ports 58a, 58b are configured to determine the location of the detected sound. Once the at least one directional microphone 55 detects a sound, the camera 22 may perform a frame lock 70 on the location of the detected sound. Described further, the camera 22 may see the entire periphery of the security device 10 as one image (e.g., a grid, a rectangle, etc.) and in response to a sound or motion, the camera 22 may then focus on the specific location of the sound, as determined by the directional microphone(s) 55. The directional microphone(s) 55, 55a, 55b may comprise an omnidirectional microphone, a unidirectional microphone, a bidirectional microphone, a cardioid microphone, and the like. Additionally, the camera 22 may also perform the frame lock 70 operation in response to the motion detector 28 detecting a motion and/or a location of the motion.

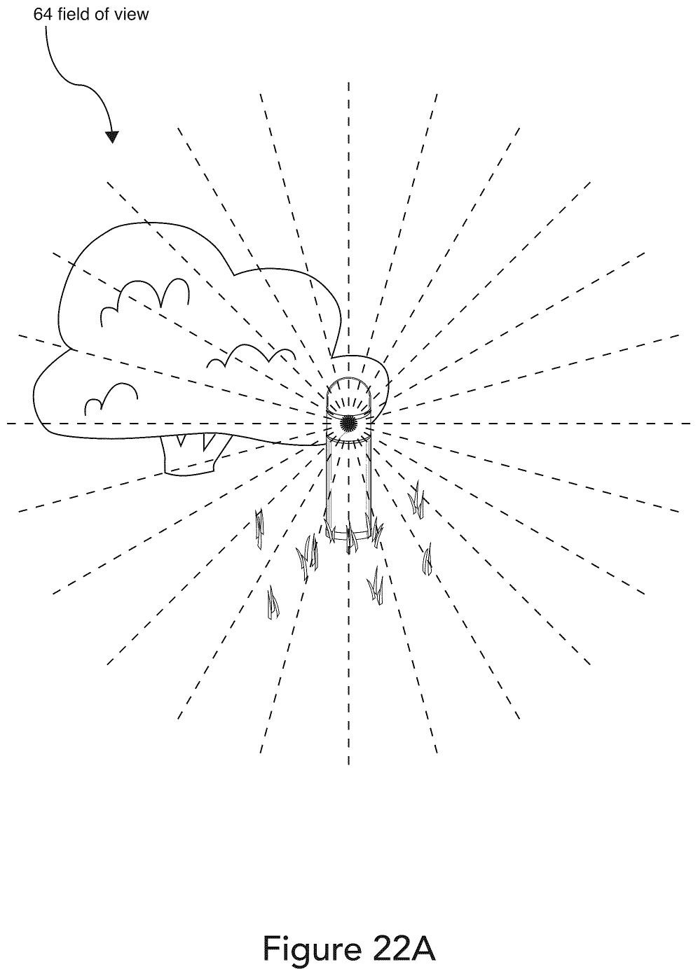

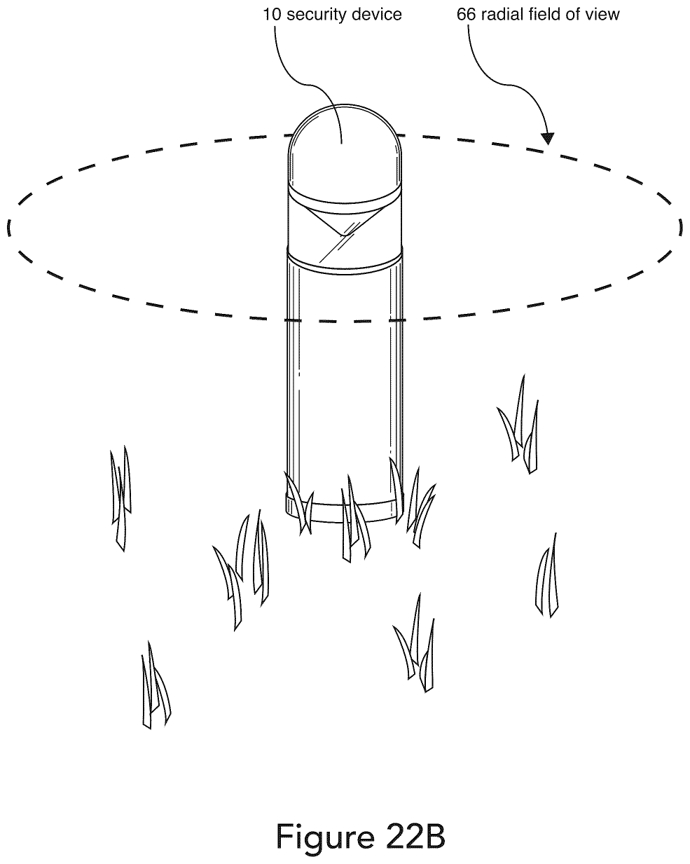

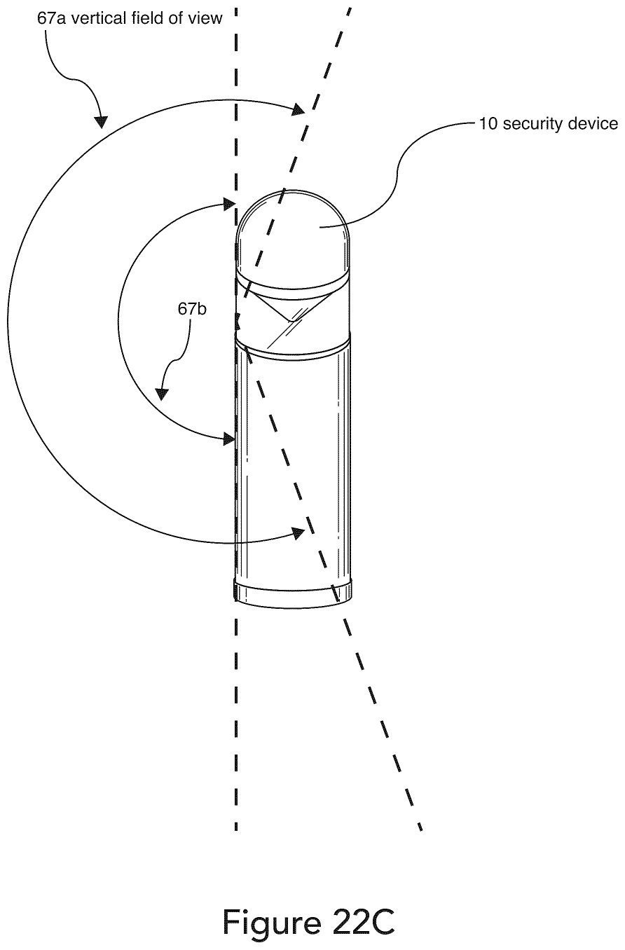

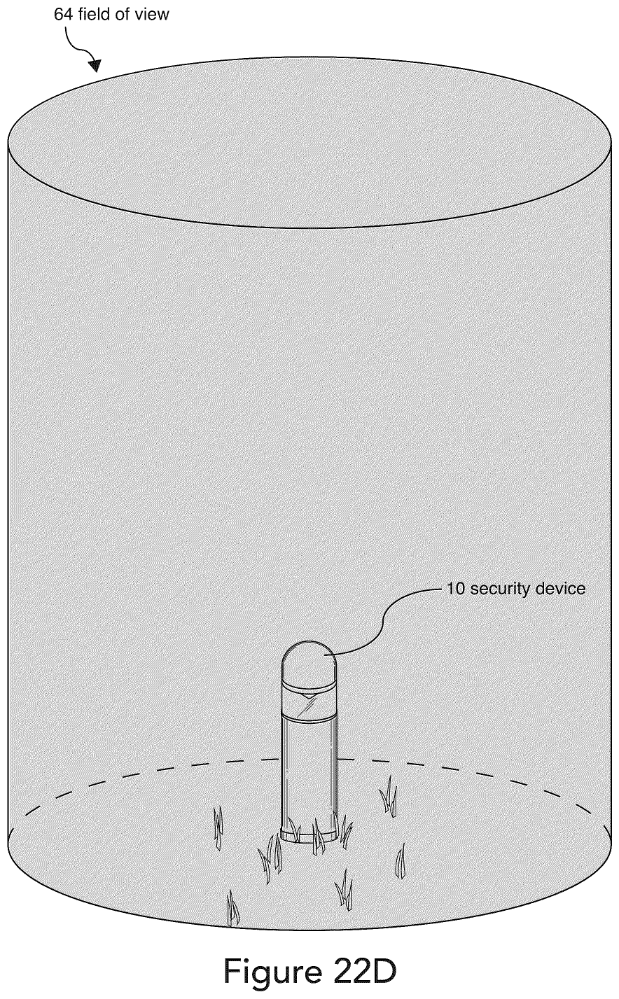

With respect to FIG. 22a, regardless of the configuration or lens, the security device 10 may be configured such that the camera 22 captures images from around the outdoor security device 10, referred to as the field of view 64.

With specific reference to FIGS. 22b and 22c, the field of view 64 also comprises a radial field of view 66 and a vertical field of view 67. The radial field of view 66 comprises a view of 360-degrees around the outdoor security device 10. The security device 10 can also be configured to capture a radial field of view less than 360-degrees, such as 180-degrees or 90-degrees. In this regard, the radial field of view can be configured to ignore certain zones or portions of the radial perimeter.

As shown in FIG. 22c, in some embodiments, the vertical field of view 67 represents a first vertical field of view 67a that extends down and back from the side of the security device 10 and covers an entire space that extends up and behind the side of the security device 10. In some embodiments, the first field of view 67a is about 220-degrees. The first field of view 67a may also be about 190-degrees, 200-degrees, 210-degrees, 230-degrees, any number in between, and the like. Explained differently, it would be the equivalent to a person being able to seeing things above and directly behind them. Explained differently, the first vertical field of view 67a would have coverage equivalent to “having eyes in the back of your head.”

With continued reference to FIG. 22c, in some embodiments, the vertical field of view 67 represents a second vertical field of view 67b that extends straight down from the side of the security device 10 and covers an entire space that extends straight up from the side of the security device. In some embodiments, the second vertical field of view 67b is about 180-degrees. The second field of view 67b may also be about 140-degrees, 150-degrees, 160-degrees, 170-degrees, any number in between, and the like. In this regard, the vertical field of view 67 may be configured to ignore certain zones or portions of the vertical space.

As shown in FIG. 22d, the radial and vertical fields of view 66, 67 together provide a comprehensive view above, below, and all around the security device 10, known as the field of view 64. Essentially, the security device 10, via the camera 22, is able to visually capture any event or object occurring within the field of view 64.

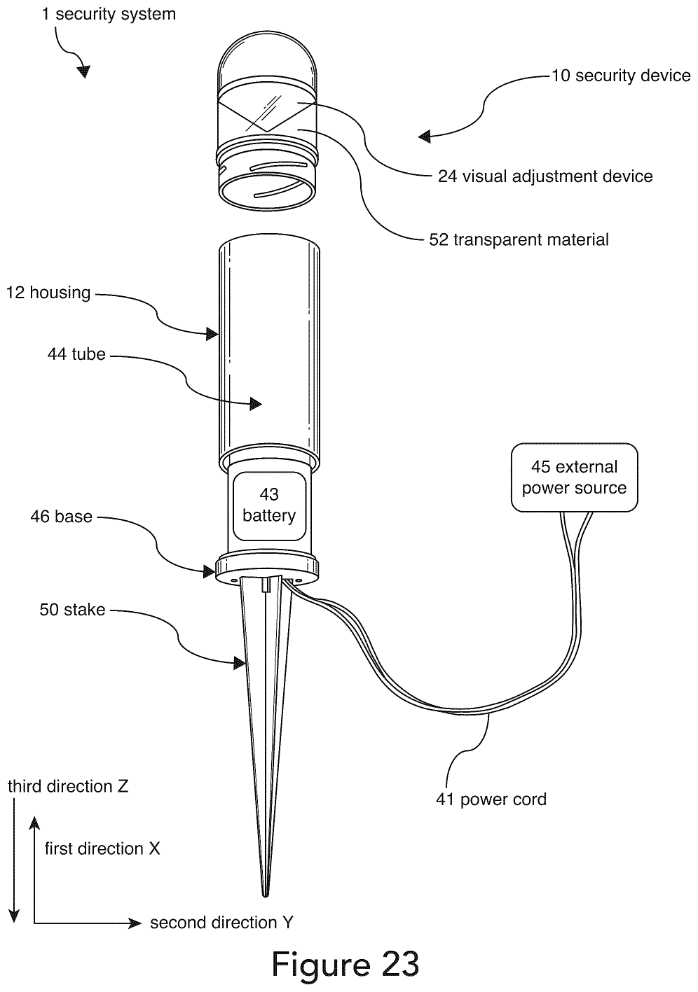

Now, with reference to FIG. 23, the security device 10 may comprise a power cord 41 electrically coupled to at least one of the battery 43, the light 20, the camera 22, the least one directional microphone 55, and/or any other electrical component described in this disclosure. In some embodiments, the power cord 41 is configured to receive power from an external power source 45, such as power from a building associated with the security device 10. Additionally, the security device 10 may include a battery 43 electrically coupled to at least one of the power cord 41, the light 20, the camera 22, the at least one directional microphone 55, and/or any other electrical component described in this disclosure. The battery 43 may be configured to provide power to at least one of the light 20, the camera 22, the at least one directional microphone 55, and/or any other electrical component described in this disclosure. In some embodiments, the battery may be configured to be recharged via power received from the power cord 41. In some embodiments, the battery 43 comprises one or more lithium ion batteries.

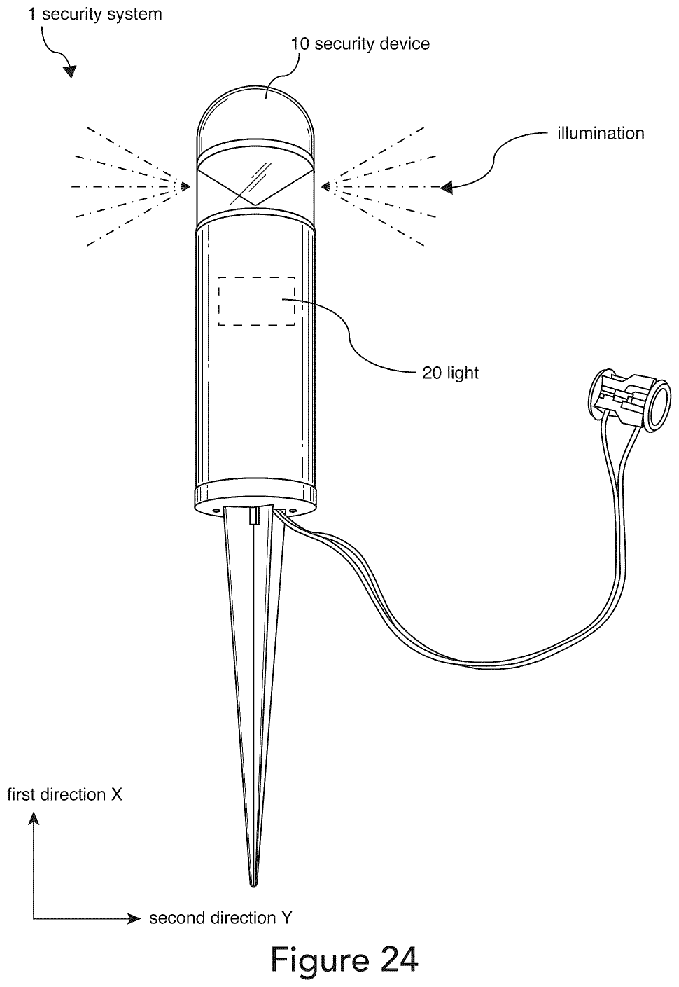

As shown in FIG. 24, the security device 10 may also include a light 20 configured to illuminate an area around the outdoor security device 10. The light 20 may be configured to not only illuminate, but also pulse in a strobing pattern. The pulsing may be configured to warn a trespasser that the security system 1 has detected the trespasser's presence. Additionally, the pulsing may be configured to draw the attention of neighbors or emergency personnel to alert them to a situation, of possible danger, at the residence associated with the system 1, such as a person falling into the swimming pool. In order to accomplish the various objectives stated herein, the strobing pattern may comprise a plurality of colors, whereby each color is intended to indicate different situations. Even still, the strobing pattern may comprise a plurality of constant or varied pulse rates.

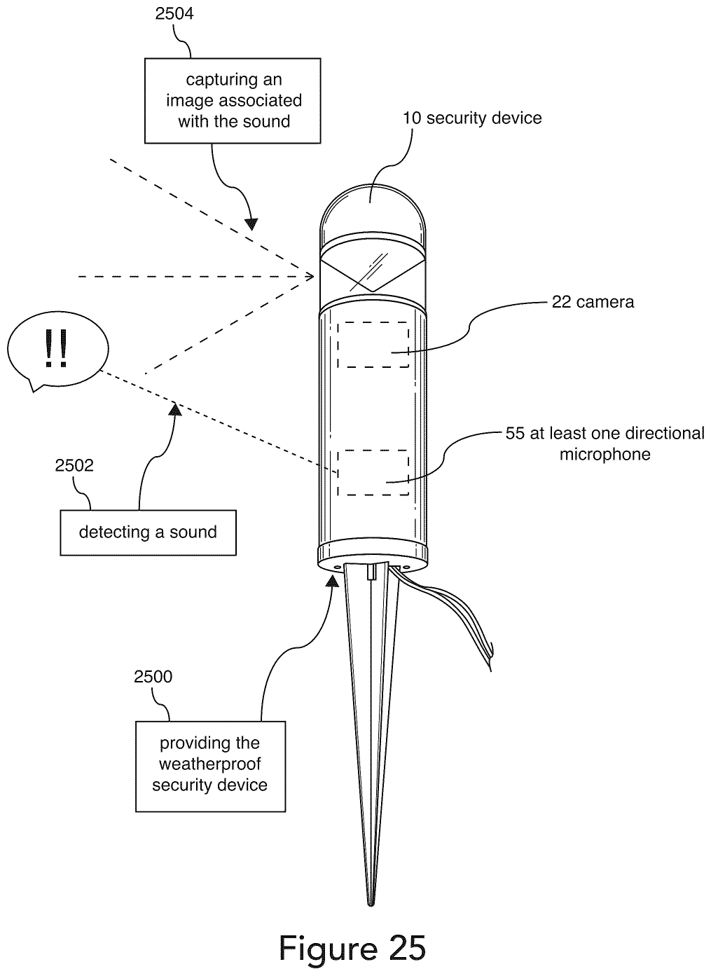

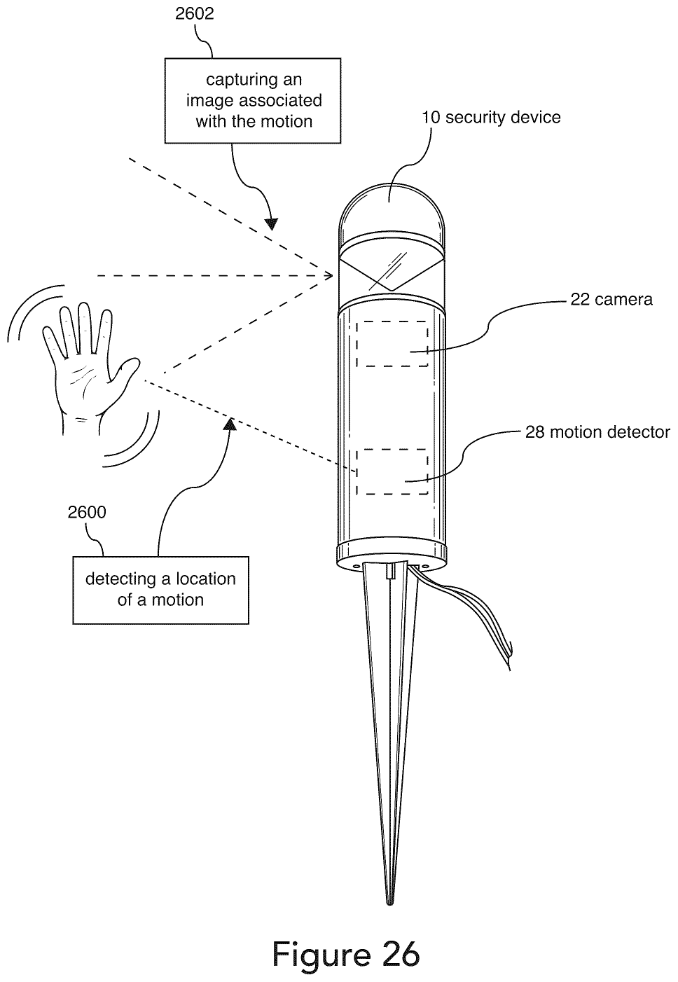

According to FIG. 25, the disclosure also includes a method of using a security system 1. Methods may include providing the weatherproof security device 10 (at step 2500), as described above. Additionally, some methods include detecting a sound via the at least one directional microphone 55 (at step 2502). In response to the detecting (step 2502), methods may include capturing, via the camera 22, an image associated with the sound (at step 2504). In some embodiments, the capturing comprises the camera 22 performing a frame lock 70 of the image associated with the detected sound.

Additionally, some methods include detecting, via the motion detector 28, an indication of a motion and/or a location of a motion (at step 2600). In response to the detecting (step 2600), some methods include capturing, via the camera 22, an image associated with the motion.

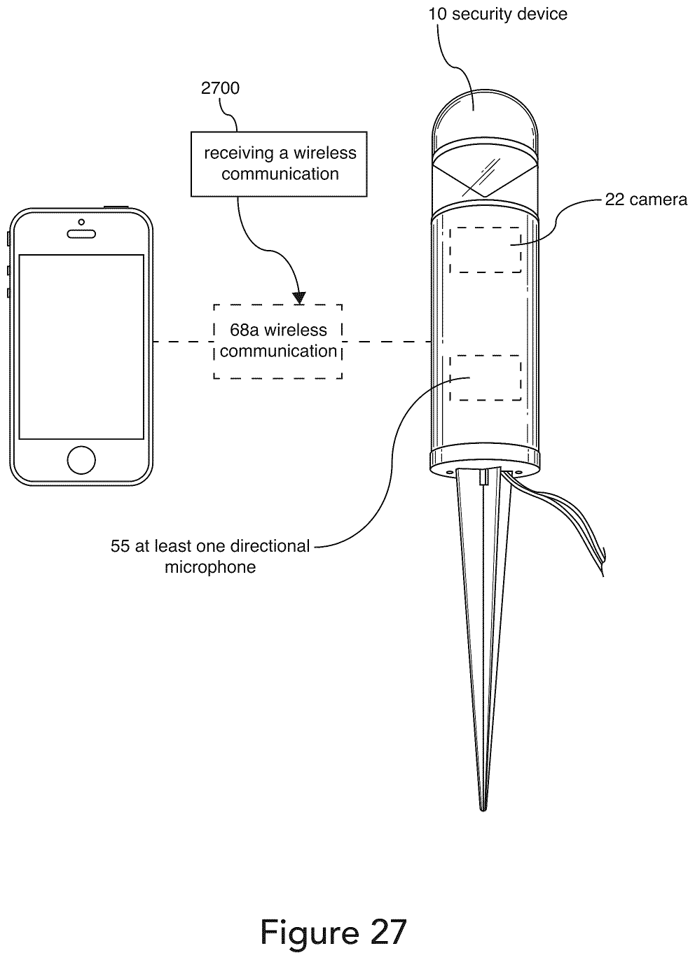

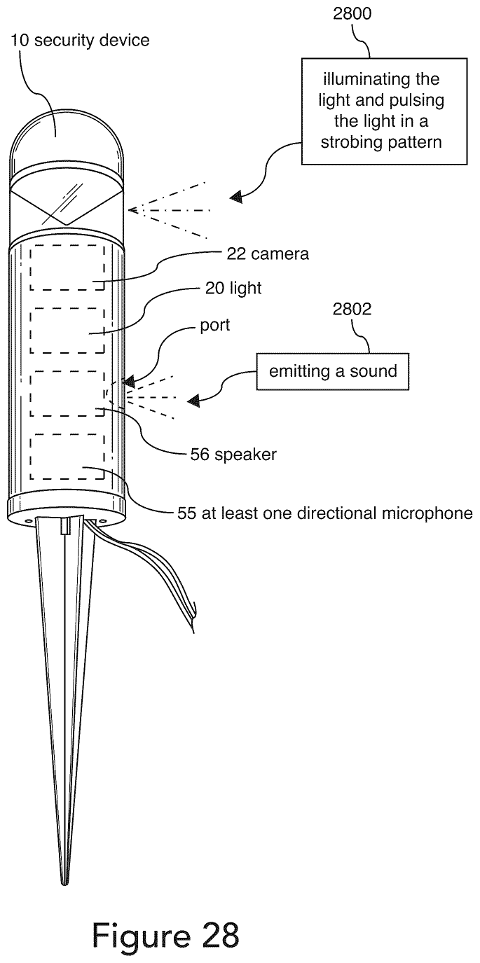

As shown in FIG. 27, in response to the detecting (steps 2502 and/or 2600), some methods include receiving, via a remote computing device 30, an alert (at step 2700). The alert may comprise an image associated with the sound or motion. In some embodiments, the alert comprises the image frame lock 70. Now with reference to FIG. 28, in response to the detecting, some methods include illuminating the light 20 and/or pulsing the light in a strobing pattern (at step 2800). Illuminating the light 20 and/or pulsing the light in a strobing pattern could be performed in response detecting the sound, receiving a wireless communication from the remote computing device 30, detecting an emergency event, and the like. Furthermore, in response to the detecting, some methods include emitting a sound from a speaker 56 (at step 2802).

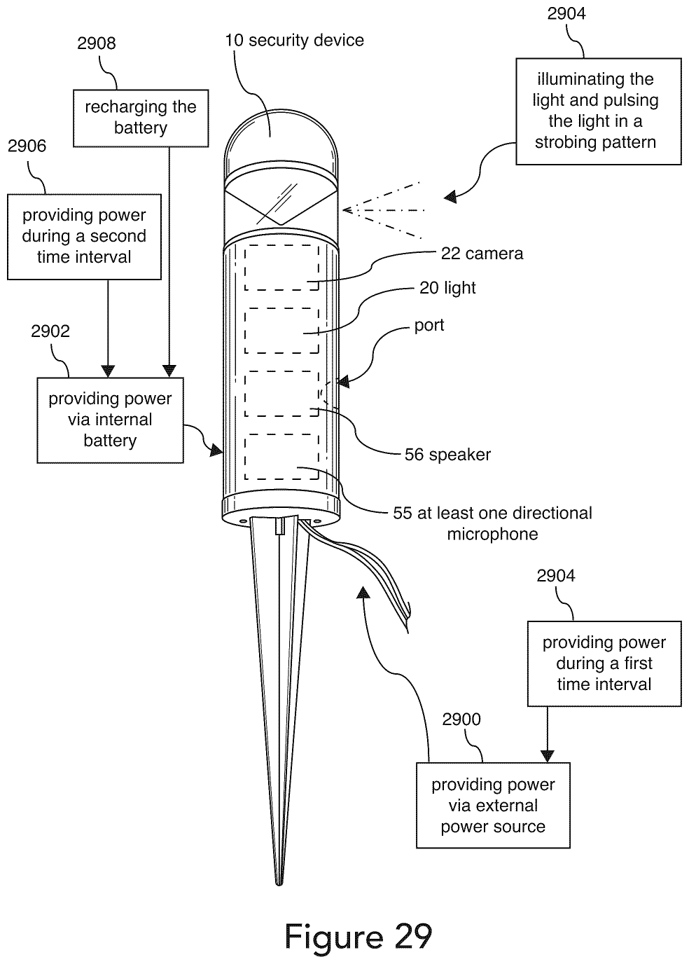

As shown in FIG. 29, some methods include providing power to at least one of the battery 43, the light 20, the camera 22, and the at least one directional microphone 55 via the power cord 41 and/or external power source 45 (at step 2900). Additionally, some methods include providing power to at least one of the light 20, the camera 22, and the at least one directional microphone 55 via the battery 43 (at step 2902). Furthermore, methods may include providing power to at least one of the battery 43, the light 20, the camera 22, and the at least one directional microphone 55 via the power cord 41 and/or external power source 45 during a first time interval (at step 2904). Also, methods may include providing power to at least one of the light 20, the camera 22, and the at least one directional microphone 55 via the battery 43 during a second time interval (at step 2906). For example, the external power source may provide power to the security device from noon to midnight (first time interval), and the battery 43 may provide power to the security device 10 from midnight to noon (second time interval). Methods may also include recharging the battery 43 via the power cord 41 and the external power source 45 during at least one of the first time interval and the second time interval (at step 2908). In some embodiments, recharging the battery only occurs during the first time interval (i.e., when the security device 10 is receiving power from the external power source 45).

### Interpretation

The term “about” is used to mean “approximately”. For example, the disclosure includes “the field of view is about 220-degrees.” In this context, “about” indicates that the field of view may be + or −5 degrees. As such, the statement above should be interpreted to mean the field of view is 215-degrees to 225-degrees.

The term “substantially” is used to mean “completely” or “nearly completely”. For example, the disclosure includes “the substantially clear portion”. In this context, the term “substantially” indicates that the clear portion is generally transparent.

The disclosure refers to various components being “coupled” to other components. It should be appreciated that any of these couplings may be direct or indirect. For example, if the specification recites that the light is coupled to the housing, this should be interpreted to mean that the light is directly or indirectly coupled to the housing.

It should be appreciated that the term “security” may be used interchangeably with the term “surveillance.”

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments include A, B, and C. The term “and/or” is used to avoid unnecessary redundancy.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

What is claimed is:

1. An outdoor security device, comprising:
a housing comprising a hollow inner portion;
a light coupled to the housing and located within the hollow inner portion;
a camera coupled to the housing, the camera configured to capture images within a field of view of the outdoor security device; and
a microphone coupled to the housing.

2. The outdoor security device of claim 1, further comprising a lens coupled to the housing.

3. The outdoor security device of claim 2, the housing further comprising a top end and a bottom end, wherein the lens is located between the camera and the top end.

4. The outdoor security device of claim 3, further comprising a visual adjustment device coupled to the housing and located along the hollow inner portion of the housing adjacent the top end, wherein the visual adjustment device is aligned with the lens and the camera such that the visual adjustment device is configured to allow the camera to capture images within the field of view of the outdoor security device.

5. The outdoor security device of claim 3, wherein the lens is selected from a group consisting of a flat lens and a convex lens, and wherein the lens is configured to allow the camera to capture images within the field of view of the outdoor security device.

6. The outdoor security device of claim 3, further comprising a substantially clear portion coupled to the housing and located adjacent the top end.

7. The outdoor security device of claim 6, wherein the camera is configured to capture images within a field of view of the outdoor security device through the substantially clear portion.

8. The outdoor security device of claim 1, wherein the microphone is communicatively coupled to the camera.

9. The outdoor security device of claim 8, wherein the microphone is a directional microphone.

10. The outdoor security device of claim 9, wherein the directional microphone is configured to determine a location of a detected sound.

11. The outdoor security device of claim 10, wherein the camera is configured to perform a frame lock to capture an image associated with the detected sound.

12. The outdoor security device of claim 8, wherein the microphone comprises a first port and a second port configured to determine a location of a detected sound.

13. The outdoor security device of claim 8, wherein the microphone is a first microphone, the outdoor security device further comprising a second microphone communicatively coupled to the camera, wherein the first microphone and the second microphone form a microphone system configured to determine a location of a detected sound.

14. The outdoor security device of claim 1, wherein the field of view is selected from a group consisting of a horizontal field of view of about 360-degrees, a vertical field of view that is less than or equal to about 220-degrees, and combinations thereof.

15. The outdoor security device of claim 1, further comprising a power cord electrically coupled to a component selected from a group consisting of the light, the camera, the microphone, and combinations thereof, and wherein the power cord is configured to receive power from an external power source.

16. The outdoor security device of claim 1, further comprising a battery electrically coupled to a component selected from a group consisting of the light, the camera, the microphone, and combinations thereof, wherein the battery is configured to provide power to the component.

17. The outdoor security device of claim 16, further comprising a power cord electrically coupled to the battery and configured to receive power from an external power source, wherein the battery is configured to be recharged via power received from the power cord.

18. The outdoor security device of claim 1, wherein the light is configured to illuminate and pulse in a strobing pattern selected from a group consisting of a single color, a plurality of colors, a single pulse rate, a plurality of pulse rates, and combinations thereof.

19. The outdoor security device of claim 1, further comprising a speaker coupled to the housing and communicatively coupled to a component selected from a group consisting of the light, the camera, the microphone, and combinations thereof.

20. The outdoor security device of claim 1, further comprising:
a wireless communication module coupled to the housing; and
an antenna coupled to the housing and communicatively coupled to the wireless communication module.
